(19) United States
(12) Patent Application Publication
(10) Pub. No.: US 2014/0011712 A1
(43) Pub. Date: Jan. 9, 2014

(54) Biodegradable Organophilic Clays for Drilling Fluids

(71) Applicant: Eric Benjamin Frantz, Houston, TX (US)

(72) Inventor: Eric Benjamin Frantz, Houston, TX (US)

(21) Appl. No.: 13/543,213

(22) Filed: Jul. 6, 2012

(51) Int. Cl. C09K 8/32

(52) U.S. Cl. 507/131; 507/129

(57) ABSTRACT

Biodegradable organophilic clays for use in drilling fluids may, in some instances, include clay treated with a surfactant system that includes biodegradable quaternary ammonium surfactants and nonbiodegradable quaternary ammonium surfactants. The biodegradable quaternary ammonium surfactant may be capable of degrading by more than about 90% over 28 days as determined by Method 306 of the OECD Guidelines for the Testing of Chemical.

### BACKGROUND

The present invention relates to biodegradable organophilic clays for use in drilling fluids, the biodegradable organophilic clays treated with a surfactant system that includes biodegradable quaternary ammonium surfactants and nonbiodegradable quaternary ammonium surfactants.

Organophilic clays are commonly used in conjunction with oil-based drilling fluids to increase the viscosity and enhance solids suspension, e.g., the suspension of drill cuttings. Bentonite is a commonly used example. Organophilic clays suitable for oilfield use are typically produced by treating a hydrophilic clay having anionic surface charges, e.g., bentonite, with a cationic surfactant. It is believed that the cationic surfactant becomes tightly bound to the clay surface through electrostatic charges, which causes the surfactant tail groups to extend into the solvent, thereby yielding an organophilic surface.

In producing organophilic clays, quaternary ammonium compounds are the most commonly used cationic surfactants. However, many of the most commonly used quaternary ammonium compounds are not biodegradable and often require expensive and time-consuming cleanup procedures. Recently, organophilic clays based on biodegradable quaternary ammonium surfactants have been utilized to reduce the cost and time associated with cleanup procedures and reduce environmental impact, especially to the marine environment and groundwater. However, the rheological properties of the drilling fluids made with such organophilic clays treated with biodegradable quaternary ammonium surfactants do not impart the same suspension properties as compared to drilling fluids that include organophilic clays treated with nonbiodegradable quaternary ammonium surfactants. Further, biodegradable quaternary ammonium surfactants can be expensive. In some instances, as much as five times more expensive.

Accordingly, it is desirable to develop a cationic surfactant system for use in producing organophilic clays that provides both biodegradability and good performance for a drilling fluid incorporating such clays, while maintaining economic viability.

### SUMMARY OF THE INVENTION

The present invention relates to biodegradable organophilic clays for use in drilling fluids, the biodegradable organophilic clays treated with a surfactant system that includes biodegradable quaternary ammonium surfactants and nonbiodegradable quaternary ammonium surfactants.

In one embodiment of the present invention, a drilling fluid may comprise: an oil-based fluid; and an organophilic clay that comprises clay treated with a surfactant system that comprises a biodegradable quaternary ammonium surfactant and a nonbiodegradable quaternary ammonium surfactant, the biodegradable quaternary ammonium surfactant being capable of degrading by more than about 90% over 28 days as determined by Method 306 of the OECD Guidelines for the Testing of Chemical.

In another embodiment of the present invention, a method may comprise: drilling at least a portion of a wellbore penetrating a subterranean formation using a drilling fluid that comprises an oil-based fluid and an organophilic clay, the organophilic clay comprising clay treated with a surfactant system that comprises a biodegradable quaternary ammonium surfactant and a nonbiodegradable quaternary ammonium surfactant, the biodegradable quaternary ammonium surfactant being capable of degrading by more than about 90% over 28 days as determined by Method 306 of the OECD Guidelines for the Testing of Chemical.

In yet another embodiment of the present invention, a method may comprise: drilling at least a portion of a wellbore penetrating a subterranean formation using a drilling fluid that comprises an oil-based fluid and an organophilic clay, the organophilic clay comprising clay treated with a surfactant system that comprises a biodegradable quaternary ammonium surfactant and a nonbiodegradable quaternary ammonium surfactant, the biodegradable quaternary ammonium surfactant being capable of degrading by more than about 90% over 28 days as determined by Method 306 of the OECD Guidelines for the Testing of Chemical, and the biodegradable quaternary ammonium surfactant comprising a biodegradable linkage that comprises at least one selected from the group consisting of an ester and an amide.

The features and advantages of the present invention will be readily apparent to those skilled in the art upon a reading of the description of the preferred embodiments that follows.

### DETAILED DESCRIPTION

The present invention relates to biodegradable organophilic clays for use in drilling fluids, the biodegradable organophilic clays treated with a surfactant system that includes biodegradable quaternary ammonium surfactants and nonbiodegradable quaternary ammonium surfactants.

The surfactant systems described herein advantageously provide for, in some embodiments, the production of organophilic clays that are both biodegradable and less costly than known organophilic clays that use only biodegradable quaternary ammonium surfactants. In some embodiments, the biodegradable organophilic clays of the present invention utilize surfactant systems that comprise biodegradable quaternary ammonium surfactants, thereby imparting desirable degradation qualities to the biodegradable organophilic clays as a whole. Further, the biodegradable organophilic clays have been shown, in some embodiments, to increase the viscosity of drilling fluids, thereby enhancing particle suspension qualities in such drilling fluids.

The surfactant systems described herein may also provide for, in some embodiments, tailoring the composition of the organophilic clays, which in turn, allows for tailoring and/or optimizing based on an operators needs for performance, price, and/or level of biodegradability.

It should be noted that when “about” is provided at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

In some embodiments, biodegradable organophilic clays of the present invention may comprise clay treated with a surfactant system that includes biodegradable quaternary ammonium surfactants and nonbiodegradable quaternary ammonium surfactants. As used herein, the term “nonbiodegradable quaternary ammonium surfactant” refers to a surfactant that degrades by less than about 90% over 28 days as determined by Method 306 of the OECD Guidelines for the Testing of Chemical. As used herein, the term “biodegradable quaternary ammonium surfactant” refers to a surfactant that degrades by more than about 90% over 28 days, as determined by Method 306 of the OECD Guidelines for the Testing of Chemicals, in force at the time of this disclosure.

Clays suitable for use in conjunction with the present invention may include, but are not limited to, a member of the smectite family, a member of the illite family, a member of the palygorskite-sepiolite phyllosilicate family, bentonite, hectorite, attapulgite, smectite, vermiculite, swellable fluoromica, montmorillonite, beidellite, saponite, sepiolite, and the like, any cation exchanged version thereof, and any combination thereof.

Biodegradable quaternary ammonium surfactants and/or nonbiodegradable quaternary ammonium surfactants suitable for use in conjunction with the surfactant systems described herein may, in some embodiments, include surfactants having a composition according to Formula I.

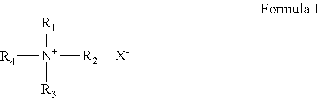

wherein R₁, R₂, R₃, and R₄ are independently selectable C₁-C₂₂ groups, optionally with at least one functional group (internal, terminal, and/or pendant to at least one carbon) selected from the group consisting of ethers, esters, anhydrides, amines, amides, alcohols, sulfates, sulfonates, thiols, alkoxides, sulfoxides, ketones, aldehydes, carboxylates, nitroalkanes, nitriles, hydroxides, halides, alkene groups, alkyne groups, aryl groups, cyclic groups, alkyl groups, acyl groups, and allyl groups; and wherein X⁻ is fluoride, chloride, bromide, iodide, methyl sulfate, ethyl sulfate, acetate, nitrite, bicarbonate, carbonate, hydroxide, or alkoxide.

In some embodiments, a biodegradable quaternary ammonium surfactant may comprise at least one tail group that comprises at least one biodegradable linkage. As used herein, the term “biodegradable linkage” refers to a chemical functionality capable of being decomposed by natural biological processes, e.g., a chemical functionality that undergoes aerobic biodegradation. Examples of preferred biodegradable linkages may, in some embodiments, include, but are not limited to, amides and esters.

Examples of suitable biodegradable quaternary ammonium surfactants may, in some embodiments, include, but are not limited to, (individually or in combination) those presented in U.S. Pat. Nos. 7,521,399 entitled “Drilling Fluids Containing Biodegradable Organophilic Clay,” 7,732,380 entitled “Drilling Fluids Containing Biodegradable Organophilic Clay,” 7,781,379 entitled “Drilling Fluids Containing Biodegradable Organophilic Clay Treated with an Amide-Containing Quaternary Ammonium Surfactant,” 7,867,953 entitled “Methods of Using Drilling Fluids Containing Biodegradable Organophilic Clay,” and 7,985,717 entitled “Methods of Using Drilling Fluids Containing Biodegradable Organophilic Clay,” the entirety of which are incorporated herein by reference. For example, in some embodiments, suitable biodegradable quaternary ammonium surfactants may include, but is not limited to, propalalkonium based amides, AMMONYX® SDBC (a stearamidopropalkonium chloride, available from Stepan Company).

Examples of suitable nonbiodegradable quaternary ammonium surfactants may, in some embodiments, include, but are not limited to, dialkyl dihydrogenated tallow ammonium surfactants, bis-decyl-diethyl ammonium surfactants, myristyltrimethyl ammonium surfactants, cetyltrimethyl ammonium surfactants, dodecyltrimethyl ammonium surfactants, ethylhexadecyldimethyl ammonium surfactants, decyltrimethyl ammonium surfactants, hexadecyltrimethyl ammonium surfactants, didodecyldimethyl ammonium surfactants, and the like, with any suitable counter ion (e.g., chlorine, bromine, and methyl sulfate), and any combination thereof.

In some embodiments, biodegradable organophilic clays of the present invention may comprise a weight ratio of the biodegradable quaternary ammonium surfactant to the nonbiodegradable quaternary ammonium surfactant ranging from a lower limit of about 1:10, 1:5, or 1:1 to an upper limit of about 10:1, 7:1, 5:1, or 3:1, and wherein the weight ratio may range from any lower limit to any upper limit and encompass any subset therebetween.

In some embodiments, biodegradable organophilic clays of the present invention may comprise a weight ratio of the clay to the surfactant system described herein ranging from a lower limit of about 1:1, 3:2; or 2:1 to an upper limit of about 5:1, 4:1, or 3:1, and wherein the weight ratio may range from any lower limit to any upper limit and encompass any subset therebetween.

In some embodiments, biodegradable organophilic clays of the present invention may be produced by a wet process. For example, in some embodiments, clay may be treated with a surfactant system described herein by first hydrating the clay in water. The resulting slurry may then be filtered through a sieve to remove impurities, followed by passing the slurry through an ion exchange column to remove divalent cations. The slurry may then be heated and stirred while the surfactant system described herein is added thereto. It may be heated at a temperature in the range of from about 140° F. to about 155° F. for a period of time effective to react the surfactants with the clay surface, so as to form an organophilic clay. Thereafter, the organophilic clay may be dried by filtering it and heating the resulting filter cake at a temperature in a range of from about 140° F. to about 150° F. for a period of time effective to dry the filter cake. The dried organophilic clay may then be ground to ensure that it can be easily dispersed in fluid. The ground organophilic clay may optionally be filtered through a sieve to generate consistent particle sizes.

In some embodiments, biodegradable organophilic clays of the present invention may be produced by a dry process. For example, in some embodiments, clay (e.g., 200 mesh clay particles) and molten surfactant system described herein may be added to an extruder, comingled, and compressed at high pressure against a perforated die plate. Without being limited by theory, it is believed that the high pressure and shear at the die plate drives a low solvent melt reaction enabling binding of cationic quaternary ammonium surfactants of the molten surfactant system to the anionic surface of the clay, thereby producing organophilic clay. The dried organophilic clay may then be ground to ensure that it can be easily dispersed in fluid. The ground organophilic clay may optionally be filtered through a sieve to generate consistent particle sizes.

In some embodiments, biodegradable organophilic clays may comprise organic content that comprises a surfactant system as described herein, the organic content having a biodegradability in seawater as determined by Method 306 of the OECD Guidelines for the Testing of Chemical ranging from a lower limit of about 10%, 20%, or 25% to an upper limit of about 40%, 35%, 30%, or 25%, and wherein the biodegradability in seawater may range from a lower limit to any upper limit and encompass any subset therebetween. As used herein, the term “organic content” relative to an organophilic clay refers to the organic materials of the organophilic clay and encompass, inter alia, surfactant systems described herein, polymers, other surfactants, carbon containing molecules, and the like.

In some embodiments, a drilling fluid may comprise an oil-based fluid and an organophilic clay treated with a surfactant system of the present invention.

Suitable oil-based fluids for use in the present invention may be any oleaginous continuous phase fluid suitable for use in subterranean operations. By way of nonlimiting example, suitable oil-based fluids may include alkanes, olefins, aromatic organic compounds, cyclic alkanes, paraffins, diesel fluids, mineral oils, desulfurized hydrogenated kerosenes, and the like, and any combination thereof.

In some embodiments, a drilling fluid of the present invention may include an invert emulsion with an oil-based continuous phase and an aqueous discontinuous phase. Suitable invert emulsions may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, and wherein the ratio may range from any lower limit to any upper limit and encompass any subset therebetween.

In some embodiments, organophilic clays described herein may be present in a drilling fluid of the present invention in an amount ranging from a lower limit of about 0.5 pounds per barrel (“lb/bbl”), 1 lb/bbl, 2 lb/bbl, or 5 lb/bbl, to an upper limit of about 15 lb/bbl, 12 lb/bbl, 10 lb/bbl, or 5 lb/bbl, and wherein the amount may range from any lower limit to any upper limit and encompass any subset therebetween.

In some embodiments, a drilling fluid may further comprise suitable additives. Suitable additives may include, but are not limited to, salts, alkali metal salts, weighting agents, inert solids, fluid loss control agents, high and low shear suspension agents, filtration aids, emulsifiers, dispersion aids, corrosion inhibitors, lubricants, emulsion thinners, emulsion thickeners, deflocculants, viscosifying agents, gelling agents, surfactants, particulates, lost circulation materials, bridging agents, pH control additives, breakers, biocides, stabilizers, scale inhibitors, gas hydrate inhibitors, mutual solvents, oxidizers, reducers, friction reducers, clay stabilizing agents, and the like, and any combination thereof. In some embodiments, preferred additives may include, but are not limited to, primary emulsifiers, secondary emulsifiers, clay stabilizers, alkali metal salts, high and low shear suspension agents, filtration aids, weighting agents, deflocculants, lost circulation materials, lubricants, and any combination thereof.

The drilling fluids described herein may, in some embodiments, be prepared by combining organophilic clays of the present invention with the other components, e.g., oil-based fluids and optionally additives. In some embodiments, the drilling fluids may be prepared at an off-site location away from the wellbore drilling site. In some embodiments, drilling fluids may be prepared on-the-fly at the wellbore drilling site.

Some embodiments may involve drilling at least a portion of a wellbore penetrating a subterranean formation using a drilling fluid that comprises an oil-based fluid and organophilic clays of the present invention. In some embodiments, the drilling fluid may serve as a drill-in fluid designed for wellbore drilling through production zones in a subterranean formation.

The exemplary biodegradable organophilic clays disclosed herein may directly or indirectly affect one or more components or pieces of equipment associated with the preparation, delivery, recapture, recycling, reuse, and/or disposal of the disclosed biodegradable organophilic clays. For example, the disclosed biodegradable organophilic clays may directly or indirectly affect one or more mixers, related mixing equipment, mud pits, storage facilities or units, fluid separators, heat exchangers, sensors, gauges, pumps, compressors, and the like, used generate, store, monitor, regulate, and/or recondition the exemplary biodegradable organophilic clays. The disclosed biodegradable organophilic clays may also directly or indirectly affect any transport or delivery equipment used to convey the biodegradable organophilic clays to a well site or downhole such as, for example, any transport vessels, conduits, pipelines, trucks, tubulars, and/or pipes used to fluidically move the biodegradable organophilic clays from one location to another, any pumps, compressors, or motors (e.g., topside or downhole) used to drive the biodegradable organophilic clays into motion, any valves or related joints used to regulate the pressure or flow rate of the biodegradable organophilic clays, and any sensors (i.e., pressure and temperature), gauges, and/or combinations thereof, and the like. The disclosed biodegradable organophilic clays may also directly or indirectly affect the various downhole equipment and tools that may come into contact with the chemicals/fluids such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

To facilitate a better understanding of the present invention, the following examples of preferred or representative embodiments are given. In no way should the following examples be read to limit, or to define, the scope of the invention.

### EXAMPLES

Two organophilic clay samples were prepared by a dry method where surfactant systems of the present invention were melted and mixing 164 g of NATIONAL® PREMIUM 200 WT (bentonite, available from Halliburton Energy Services, Inc.). The two surfactant systems used were (Sample 1) 29 g VARIQUAT B 343 A (a dimethyl dihydrogenated tallow ammonium chloride surfactant, available from Evonik Industries) and 127 g AGENT 4356-44 (a quaternary ammonium surfactant with detail group having a carbonyl linkage, available from Stepan Company) and (Sample 2) 38 g VARIQUAT B 343 A and 109 g AGENT 4356-44. The mixture was extruded at 150° C. using a laboratory scale extruder. The material was then dried overnight at 105° C. After cooling for several hours, the dried material was passed through a Raymond laboratory scale hammer mill four times to yield approximately 75% of the material having sub-200 mesh size.

Four drilling fluid samples were prepared according to the compositions provided in Table 1 using Sample 1 and Sample 2 from above, Sample 3 (an organophilic clay treated with only a biodegradable quaternary ammonium surfactant) (an organophilic clay treated with a biodegradable quaternary ammonium surfactant), and GELTONE® II (an organophilic clay treated with a nonbiodegradable quaternary ammonium surfactant, available from Halliburton Energy Services, Inc.).

TABLE 1

| | Sample | Sample | Sample | GELTONE ® |
|---|---|---|---|---|
| | 1 | 2 | 3 | II |
| organophilic clay (lb) | 9.0 | 9.0 | 9.0 | 6.0 |
| CLAIRSOL ® NS* (bbl) | — | — | — | 0.542 |
| EDC ® 95-11* (bbl) | 0.542 | 0.542 | 0.542 | — |
| EX-MUL ® NT* (lb) | 9.0 | 9.0 | 9.0 | 9.0 |
| lime (lb) | 5.0 | 5.0 | 5.0 | 7.0 |
| DURATONE ® HT* (lb) | 9.0 | 9.0 | 9.0 | 9.0 |
| water (bbl) | 0.18 | 0.18 | 0.18 | 0.18 |
| CaCl₂ (lb) | 15.6 | 15.6 | 15.6 | 15.6 |
| barite (lb) | 292.0 | 292.0 | 292.0 | 292.0 |

*GELTONE ® II (an organophilic clay viscosifier, available from Halliburton Energy Services, Inc.); CLAIRSOL ® NS (a very low toxicity base-oil, available from Petrochem Carless Limited); EDC 95-11 (a biodegradable base-oil, available from Total Fluids); EX-MUL ® NT (an invert emulsifier, available from Halliburton Energy Services, Inc.); DURATONE ® HT (a modified lignitic, available from Halliburton Energy Services, Inc.)

The rheology of the drilling fluid samples were tested at three time points (1) initially after making the drilling fluid, (2) after hot rolling (“HR”) the drilling fluid at 150° F. for 16 hours, and (3) after hot rolling the drilling fluid at 250° F. for 16 hours. The rheological testing methods utilized were API RP 13B-2 and API RP 13I at 120° F.

TABLE 2

| | | | | | | | |
|---|---|---|---|---|---|---|---|
| plastic | | | | | | | |
| viscosity | yield point | | | | | | |
| (cP) | (lb/100 ft²) | 600 rpm | 300 rpm | 200 rpm | 100 rpm | 6 rpm | 3 rpm |

Sample 1

| | | | | | | | | |
|---|---|---|---|---|---|---|---|---|
| initial | 50 | 19 | 119.0 | 69.0 | 51.5 | 32.5 | 9.5 | 7.5 |
| HR 16 hr | 48 | 22 | 118.0 | 70.0 | 52.0 | 33.5 | 9.5 | 7.5 |
| at 150° F. | | | | | | | | |
| HR 16 hr | 43 | 19 | 105.0 | 62.0 | 47.0 | 31.0 | 9.0 | 7.5 |
| at 250° F. | | | | | | | | |

Sample 2

| | | | | | | | | |
|---|---|---|---|---|---|---|---|---|
| initial | 51.5 | 23 | 126.0 | 74.5 | 56.5 | 37.0 | 11.0 | 9.5 |
| HR 16 hr | 49.5 | 21.5 | 120.5 | 71.0 | 55.0 | 37.0 | 12.0 | 10.5 |
| at 150° F. | | | | | | | | |
| HR 16 hr | 49 | 32 | 130.0 | 81.0 | 62.5 | 42.5 | 14.5 | 12.0 |
| at 250° F. | | | | | | | | |

Sample 3

| | | | | | | | | |
|---|---|---|---|---|---|---|---|---|
| initial | 42 | 15 | 99 | 57 | 41 | 26 | 7 | 6 |
| HR 16 hr | 46 | 16 | 108 | 62 | 47 | 30 | 8 | 7 |
| at 150° F. | | | | | | | | |
| HR 16 hr | 44 | 22 | 110 | 66 | 50 | 32 | 10 | 8 |
| at 250° F. | | | | | | | | |

GELTONE ® II

| | | | | | | | | |
|---|---|---|---|---|---|---|---|---|
| initial | 29 | 15 | 73 | 44 | 34 | 23 | 19 | 14 |
| HR 16 hr | 29 | 17 | 75 | 46 | 36 | 20 | 15 | 10 |
| at 250° F. | | | | | | | | |

This example demonstrates, inter alia, the ability to tailor the rheological properties of drilling fluids by tailoring the composition of the organophilic clays of the present invention (i.e., clay having been treated with surfactant systems of the present invention). Advantageously, the desired rheological properties of the drilling fluids can be achieved or exceeded utilizing less expensive organophilic clays (e.g., Sample 2 as compared to IDP-572) while utilizing a surfactant system comprising biodegradable quaternary ammonium surfactants.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A drilling fluid comprising:
an oil-based fluid; and
an organophilic clay treated with a surfactant system that comprises a biodegradable quaternary ammonium surfactant and a nonbiodegradable quaternary ammonium surfactant, the biodegradable quaternary ammonium surfactant being capable of degrading by more than about 90% over 28 days as determined by Method 306 of the OECD Guidelines for the Testing of Chemical.

2. The drilling fluid of claim 1, wherein the biodegradable quaternary ammonium surfactant comprises a biodegradable linkage.

3. The drilling fluid of claim 2, wherein the biodegradable linkage is an amide.

4. The drilling fluid of claim 2, wherein the biodegradable linkage is an ester.

5. The drilling fluid of claim 1, wherein clay comprises at least one selected from the group consisting of a member of the smectite family, a member of the illite family, a member of the palygorskite-sepiolite phyllosilicate family, bentonite, hectorite, attapulgite, smectite, vermiculite, swellable fluoromica, montmorillonite, beidellite, saponite, sepiolite, and the like, any cation exchanged version thereof, and any combination thereof.

6. The drilling fluid of claim 1, wherein the weight ratio of the biodegradable quaternary ammonium surfactant to the nonbiodegradable quaternary ammonium surfactant ranges from about 1:10 to about 10:1.

7. The drilling fluid of claim 1, wherein the weight ratio of the clay to the surfactant system ranges from about 1:1 to about 5:1.

8. The drilling fluid of claim 1, wherein the oil-based fluid is an invert emulsion.

9. A method comprising:
drilling at least a portion of a wellbore penetrating a subterranean formation using a drilling fluid that comprises an oil-based fluid and an organophilic clay treated with a surfactant system that comprises a biodegradable quaternary ammonium surfactant and a nonbiodegradable quaternary ammonium surfactant, the biodegradable quaternary ammonium surfactant being capable of degrading by more than about 90% over 28 days as determined by Method 306 of the OECD Guidelines for the Testing of Chemical.

10. The method of claim 9, wherein the biodegradable quaternary ammonium surfactant comprises a biodegradable linkage.

11. The method of claim 10, wherein the biodegradable linkage is an amide.

12. The method of claim 10, wherein the biodegradable linkage is an ester.

13. The method of claim 9, wherein the weight ratio of the biodegradable quaternary ammonium surfactant to the nonbiodegradable quaternary ammonium surfactant ranges from about 1:10 to about 10:1.

14. The method of claim 9, wherein the weight ratio of the clay to the surfactant system ranges from about 1:1 to about 5:1.

15. The method of claim 9, wherein the oil-based fluid is an invert emulsion.

16. A method comprising:
drilling at least a portion of a wellbore penetrating a subterranean formation using a drilling fluid that comprises an oil-based fluid and an organophilic clay, the organophilic clay treated with a surfactant system that comprises a biodegradable quaternary ammonium surfactant and a nonbiodegradable quaternary ammonium surfactant, the biodegradable quaternary ammonium surfactant being capable of degrading by more than about 90% over 28 days as determined by Method 306 of the OECD Guidelines for the Testing of Chemical, and the biodegradable quaternary ammonium surfactant comprising a biodegradable linkage that comprises at least one selected from the group consisting of an ester and an amide.

17. The method of claim 16, wherein the weight ratio of the biodegradable quaternary ammonium surfactant to the nonbiodegradable quaternary ammonium surfactant ranges from about 1:10 to about 10:1.

18. The method of claim 16, wherein the weight ratio of the clay to the surfactant system ranges from about 1:1 to about 5:1.
